(19) United States
(12) Patent Application Publication
(10) Pub. No.: US 2003/0165354 A1
(43) Pub. Date: Sep. 4, 2003

(54) Device with a shaft and with at least one hub mounted on said shaft, and method for producing said device

(76) Inventor: Lukas Matt, Mauren (DE)

Correspondence Address: Max Fogiel, 61 Ethel Road West, Piscataway, NJ, 08854, US

(21) Appl. No.: 10/297,356

(22) PCT Filed: Apr. 20, 2001
(86) PCT No.: PCT/DE01/01525

(30) Foreign Application Priority Data
Jun. 6, 2000 (DE) 10027517

(51) Int. Cl. B25G 3/28

(52) U.S. Cl. 403/282

(57) ABSTRACT

The invention relates to a device that comprises a shaft (1) and a hub (2) mounted on said shaft (1). Said hub (2) has an opening (3) which has a composite profile in the direction of its axis (A). Said profile comprises a cylindrical section (Z) and a conical section (K1). The cone-generating angle alpha of the cone (K1) is smaller or equal 5 degree. The transition (e) between the mentioned sections (Z, K1) of the profile is located in the hub opening (3), approximately in the center section of the hub width (B).

The present invention concerns a rotary shaft with at least one nave mounted thereon. The invention also concerns a method of manufacturing the device.

Mounting a nave at a desired point along a shaft by enlarging the shaft by plastic deformation, e.g. rolling, squeezing, or driving and then forcing the nave over the enlarged section is known.

European Patent 0 521 354 for example describes a composite camshaft with cams secured to it as just described. The circumference is expanded at this point by rolling. The navels bore is generally cylindrical, but the end that initially comes into contact with the expanded section of the shaft specially contoured in the form of a cone with an apical angle of approximately 20 • extending axially over approximately ⅕ of the total width of the nave. This design has drawbacks that are detrimental to the operation and function of a dynamically highly stressed shaft-to-nave joint. One drawback is that the axial width of an entering bore bevel with an angle of approximately 20 • angle cannot be exploited for the joint as such because it is appropriate only for the plastic deformation and compression of the shaft's beads and can make no contribution to securing the nave. At a given nave width, the entering bevel in the known design leads to a coverage loss of fifteen to twenty percent of the total nave width, which is very detrimental. Another drawback of the known design is that the highest strain peeks in the nave occur immediately at the end of the entrance cone. Since this end of the cone is in the vicinity of the periphery of one face of the nave, any defects in the periphery (e.g. forging errors or defective hardness at the periphery of the bore) will unavoidably result in cracks. This known design is accordingly inappropriate for highly stressed joints. A third drawback is that, since the nave does not interlock with the shaft, a long-lasting joint cannot be insured.

WO 99/5740 discloses a shaft-to-nave joint whereby the shaft is enlarged before being attached at the outside by reshaping at the joint of attachment. The nave entrance in this event is not constituted in this case by a bevel with an interior transitional edge but by an opening curve that merges tangentially into a cylindrical nave bore. This design as well does not prevent high peak strain at the periphery of the nave's face, and accordingly also leads to cracks an that vicinity and hence to the failure of the joint. The entering radius of this design is also unable to transmit torque and is accordingly able only to reshape the beads on the shaft. The effectively exploitable width of the nave will also be sensitively decreased by this entering structure.

At this state of the art, the first shaft beads, which are reshaped by the entering bevel or by the entering curve, will subsequently be run over by the total width of the nave and hence abrasively damaged. In consequence of this abrasive skating there will occur a loss of tension between the shaft and the nave that will be detrimental to the joint.

The object of the present invention is to make available an interlocking and frictional joint, to decrease the abrasive skating while the joint is being established and hence to increase the consequent tension and simultaneously displace the joint's strains from the critical periphery to an uncritical area.

This object is achieved in accordance with the present invention in a device of the aforesaid genus as recited in the body of claim 1.

Various embodiments of the present invention will now be specified with reference to the accompanying whereby

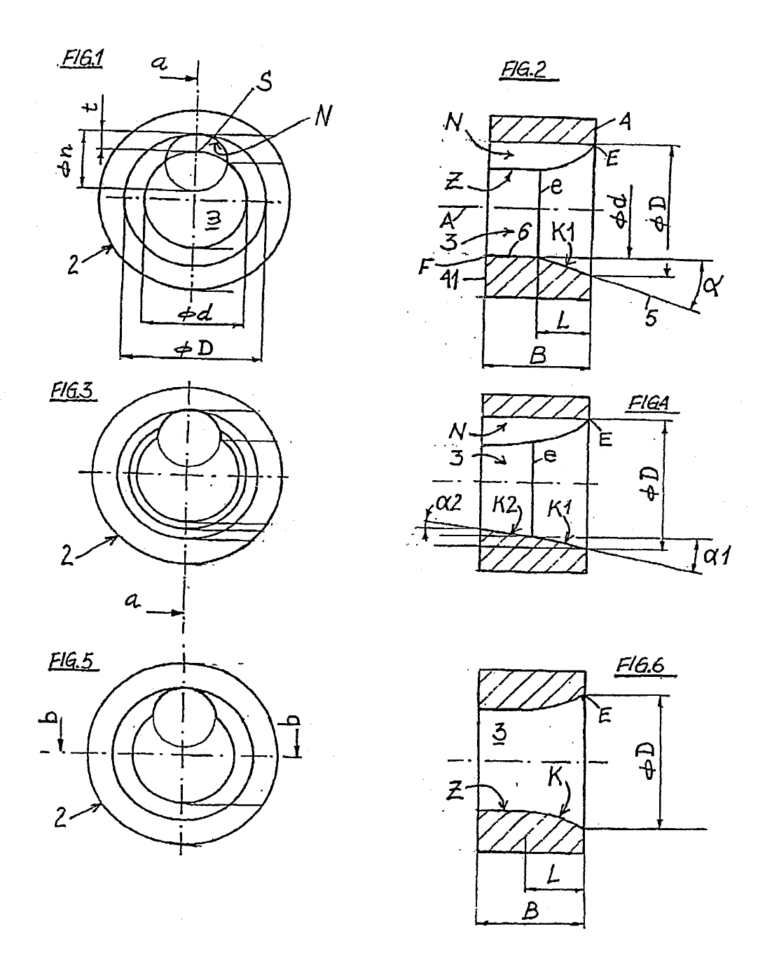

FIG. 1 is a front view of one embodiment of the nave in accordance with the present invention,

FIG. 2 is a vertical section a-a through the nave illustrated in FIG. 1, whereby the navels bore is provided with a truncoconical inner surface and with a cylindrical inner surface,

FIG. 3 is a front view of another embodiment of a nave in accordance with the present invention,

FIG. 4 is a section a-a through the nave illustrated in FIG. 3, whereby the bore is provided with two inner surfaces,

FIG. 5 is a front view of a third embodiment of the nave in accordance with the present invention,

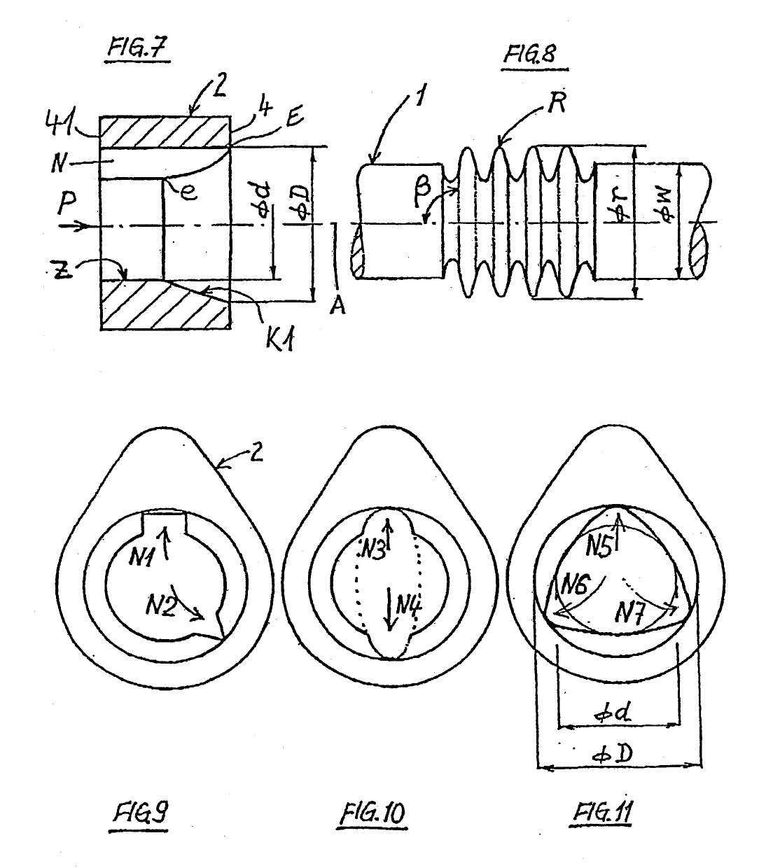

FIG. 6 is a section b-b through the nave illustrated in FIG. 5 whereby the conical inner surface of the bore merges continuously into the cylindrical inner surface of the nave opening,

FIGS. 7 and 8 illustrate the nave illustrated in FIG. 1 as compared with a section of the shaft before establishment of the joint, and

FIGS. 9, 10 and 11 are front views of naves with bores of various geometries.

The present invention comprises a rotating shaft 1 (FIG. 8) and at least one nave 2 (FIGS. 1 through 7 and 9 through 11) that can be mounted thereon. The dimensions represented in the figures are highly distorted for the sake of clarity. Shaft 1 and nave 2 are for the same purpose represented before being attached together. Depending on the particular application, nave 2 can be intended for a cam plate, a cogwheel, a crank cheek, a wheel, an eccentric, etc. and consist of hardened or unhardened steel, sintered steel, cast material, plastic, etc. To conserve weight, shaft 1 will preferably be a welded cold-drawn steel cylinder.

FIGS. 1 and 2 illustrate one embodiment of the present nave 2 with two parallel faces 4 and 41. Faces 4 and 41 are preferably at a right angle to the central axis or axis A of symmetry. The distance between faces 4 and 41 defines the width B of nave 2. Although width B can of course decrease or increase as it departs axially from where it is secured to the shaft, in the event that the nave is intended for a cam for example, the figures, for simplicity's sake, represent it as constant. A bore 3 extends through the center of nave 2. Bore 3 is provided with a cylindrical inner surface Z that extends at one end as far as the second face, face 41, of nave 2. Bore 3 is also provided with a second inner surface K1 that deviates conically out from the cylindrical and extends at one end to the first face, face 4 of nave 2. Inner surface Z and inner surface K1 merge inside nave 2. Inner surface K1 is represented in FIGS. 1 and 2 by a single straight truncoconicular-surface generator 5. In conjunction with a line paralleling the axis A of nave 2, surface generators 5 as a whole describe an apical angle α. The generators 5 of truncoconical inner surface K1 intersect with the first face 4 of nave 2 at an edge E. Cylindrical inner surface Z is represented in FIGS. 1 and 2 by a single straight generator 6. Straight cylindrical-surface generators 6 parallel the axis A of nave 2. The straight generators 6 of cylindrical inner surface Z intersect with the second face 41 of nave 2 at an edge F. Edges E and F are continuous and preferably circular. The transition between the truncoconical inner surface K1 and the cylindrical inner surface Z of bore 3 is defined by an edge e. Although the highest peak strain occurs at transitional edge e, they can be displaced to the center of the nave to prevent cracking.

FIG. 7 illustrates the nave 2 illustrated in FIG. 1 ready to be thrust in direction P over the end of the shaft 1 illustrated in FIG. 8. Shaft 1 can be solid or hollow. The unmodified inner surface of the shaft will preferably be cylindrical, its outside width being w. Beads R with an outside diameter r have been produced along the shaft by plastic deformation of its material at every position where a nave 2 is to be attached. FIG. 8 depicts one possible embodiment of beads R with intermediate grooves. Both the beads and the groove are discrete and at a right angle to the axis. It would, however, also be possible for these beads to be continuous and to wrap around the shaft like the thread of a screw, although such an embodiment is not illustrated herein. The beads in another practical but unillustrated embodiment can be in the form of cogs extending axially to the shaft's axis of symmetry.

In assembling, a longitudinal-squeeze bond is produced between shaft 1 and nave 2 in an embodiment wherein the outside diameter r of beads R is longer than the diameter d of the cylindrical inner surface Z of bore 3. In this event, nave 2 is, with the edge E with diameter D leading, initially thrust over shaft 1 in direction P. It will be practical at this stage for nave 2 prior to the rolling of beads R to remain loose or only slightly resting along shaft 1. The diameter d of cylindrical inner surface Z will in this event accordingly approximately equal the width w of the unshaped sections of shaft 1. This condition can be achieved by adjusting the tolerance between diameter d and width w by leaving free play or with a transitional fitting.

To achieve a tight and lasting joint between nave 2, it is necessary to prevent edge E from damaging beads R while the nave is being forced into position. The projecting beads R in the rolled section must accordingly be removed from the section with the inner surface K1 as soon as they come into contact with it. The diameter D of the edge E of nave 2 must also be as long as or longer than the outside diameter r of beads R.

The length L (FIG. 2) of truncoconical inner surface K1 is approximately half the width B of nave 2. This is an important feature of the present invention and also means that only about half the beads R will be abrasively flattened by the cylindrical inner surface Z of bore 3 while the beads are being forced into place. This feature further stabilizes the joint between nave 2 and shaft 1.

Since apical angle α is 5 • or less, truncoconical inner surface K1 will definitely remain in the self-inhibiting range. The junctional strains in this section of nave 2 will increase constantly until the nave arrives in its final position on shaft 1 but without detriment to the bore's periphery. For this reason, conical inner surface K1 will contribute considerably to extending the life of the joint.

When the joint in accordance with the present invention must satisfy high demands for static and dynamic resistance to torsion, the halves will need to interlock as well rather than just be maintained relative to each other by friction. Such additional interlocking can be achieved by providing bore 3 with one or more depressions N (FIG. 1) in addition to a truncoconical inner surface K, interrupting the bore's total circularity. The depth t of such a depression N is represented in FIG. 1 as D minus d. Geometrically, the depression is a section of the surface of a cylinder, its axis S of symmetry preferably paralleling the axis A of symmetry of bore 3. As nave 2 is thrust onto shaft 1, truncoconical inner surface K1 will deform beads R, and some of the beads will force their way into depression N, resulting in an interlocking connection that extends over almost the total width B of the nave. The overall width B of the nave can now be exploited to secure nave 2 to shaft 1, and there can be no loss of an effectively supporting fastening width on the part of nave 2.

FIGS. 3 and 4 illustrate a nave with a bore 3 comprising two directly communicating and mutually aligned truncoconical inner surfaces K1 and K2. Structures depicted in FIGS. 3 and 4 and similar to those in FIGS. 1 and 2 are identically labeled. Apical angle α1 belongs to the first section of bore 3 with the truncoconical inner surface, and apical angle α2 to its second section, also with a truncoconical inner surface K2. These angles are preferably 5 • or less. The transitional edge e between inner surfaces K1 and K2 is positioned approximately halfway along the width B of the nave. The peak strain at edge e is accordingly again in this embodiment effectively kept away from the critical periphery. As previously specified with reference to FIGS. 1 and 2, depression N again acts as an interlocking connection between shaft 1 and nave 2 over the total width B of the nave.

FIGS. 5 and 6 illustrate a nave 2 with an inner surface K3 that merges constantly and continuously into the cylindrical inner surface Z of bore 3. This embodiment needs no interior edge e. Here as well, the maximal junctional strains occur at the transition between the initial surface K3 and the cylindrical inner surface Z of bore 3, prolonging the life of the joint but without causing cracks in nave 2. The cross-section of the inner surface K3 of initial section can be in the form of a circle or of some other geometric curve. In this embodiment as well, depression N provides an interlocking connection over the total width B of the nave.

Since the present invention needs no entering section with a bevel or fractional round to allow the shaft to be rolled, the total width B of the nave will be available for securing the joint. As it first comes into contact with nave 2, the first rolled bead R will be constantly reshaped as the nave is thrust onto the shaft, the tension between shaft 1 and nave 2 increasing constantly until the nave has arrived in its final position. The compression will accordingly be much more powerful than at the state of the art, preventing any decrease in the strains in the first beads R to be reshaped. The joint will on the whole hold much more dependably.

FIGS. 9 through 11 illustrate different versions of depression N. FIG. 9 depicts a bore 3 with two groove-like depressions N1 and N2 at an angle of 120 • apart. FIG. 10 shows two depressions N3 and N4, each in the shape of a parabola and confronting each other at an angle of 180 •. Such depressions, however, need not have algebraic contours. FIG. 1 depicts a bore 3 with depressions N5, N6, and N7 in the form of apices of a Rouleau triangle (based on an unillustrated circle) or of a polygon. The polygon illustrated in FIG. 11 partly overlaps the cross-section of a section with an inner surface K1 with defining diameters d and D.

Bore 3, inner surfaces K1 and K2, and depressions N through N7 can be economically produced by machining—turning and/or broaching for example. Instead of being machined, however, the nave can also be produced by other means, by sintering for instance.

From the foregoing it will be evident that the present device comprises a rotating shaft 1 and a nave 2 mounted thereon. The nave is provided with a bore 3 with a compound inner surface along the navels axis A of symmetry, comprising a cylindrical inner surface Z that merges into a truncoconical inner surface K1. The apical angle α is 5 • or less. An edge e that represents the transition between cylindrical inner surface Z and truncoconical inner surface K1 is located inside the bore about half-way along its width B.

1. Device comprising a shaft and at least one nave mounted thereon, characterized in that at least one end of the bore (3) extending through the nave has an inner surface K in longitudinal section.

2. Device as in claim 1, characterized in that, about half-way along the width (B) of the nave, the inner surface (K) merges into the bore (3).

3. Device as claim 1, characterized in that the inner surface (K) is a conical inner surface (K1).

4. Device as in claim 3, characterized in that the apical angle (α) of the inner surface (K1) is 5 • or less.

5. Device as in claim 1, characterized in that the inner surface (K) is a constant contour that merges continuously into the bore (3).

6. Device as claim 1, characterized in that the bore (3) has either a cylindrical inner surface (Z) or a conical inner surface (K2).

7. Device as in claim 1, characterized in that the bore (3) has at least one depression (N) extending along its width (B).

8. Device as in claim 7, characterized in that the depression (N) is cylindrical, prismatic, elliptical, or polyhedral.

9. Method of manufacturing a device as in claim 1, characterized in that the bore (3) with its inner surface (K) and depression (N) is produced either by machining, specifically by turning and/or broaching, or otherwise, specifically by sintering.

10. Method as in claim 13 [sic], characterized in that the shaft is expanded at at least one point along the joint by plastic deformation of its outer circumference and in that the nave (2) is axially forced over that point.
